(19) United States
(12) Patent Application Publication
(10) Pub. No.: US 2002/0012287 A1
(43) Pub. Date: Jan. 31, 2002

(54) Continuous mixing apparatus

(76) Inventors: Hideyuki Mori, Fukui Prefecture (JP); Atsushi Komatsu, Chiba Prefecture (JP); Makaoto Kokubun, Chiba Prefecture (JP); Toyohiko Yamadera, Chiba Prefecture (JP); Mitsuo Hamada, Chiba Prefecture (JP)

Correspondence Address: Dow Corning Corporation, Intellectual Property Department, Mail Co1232, P.O. Box 994, Midland, MI, 48686-0994, US

(21) Appl. No.: 09/918,857

(22) Filed: Jul. 31, 2001

(30) Foreign Application Priority Data
Jul. 31, 2000 (JP) 2000-232146

(51) Int. Cl. B01F 7/26; B01F 15/02

(52) U.S. Cl. 366/171.1; 366/172.1; 366/172.2; 366/294; 366/303; 366/312; 366/317

(57) ABSTRACT

A continuous mixing apparatus in which subsequently replenished liquid does not rise to the top of the mixing apparatus, and a mixture that is uniform, highly stable, and has either a small particle size or a low viscosity, can be manufactured quickly.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

This invention is directed to an apparatus for continuously mixing different types of material. More particularly, it is directed to a mixing apparatus for continuously manufacturing a liquid mixture, or a mixture containing a large amount of liquid, by continuously supplying different types of materials such as liquids or powders and liquids, into a casing. These materials are mixed by rotation of an upper rotary disk and a lower rotary disk. The disks rotate independently of each other and continuously create a crude mixture. The casing can be continuously replenished with liquid and mixed with the crude mixture.

### BACKGROUND OF THE INVENTION

Japanese Patent Application Publication No. 2000-449A discloses a method in which a liquid organopolysiloxane, an emulsifier, and water, are supplied to a mixing chamber, and a grease in the form of an organopolysiloxane aqueous liquid is manufactured by rotation of a rotary disk equipped with a scraper. However, because emulsification is performed in a dilute state from the outset it is a problem in that the particle size of the emulsion is large and the emulsion is unstable.

U.S. Pat. No. 4,691,867 (Sep. 8, 1987) discloses a continuous mixing apparatus for creating a slurry from a micro-powder and a powder such as oil coke. In the '867 patent, a powder and a liquid are introduced into an upper mixing chamber, and the powder is wetted by the liquid via rotation of an upper rotary mixing disk, to create a wet crude mixture. The crude mixture is transferred to a lower mixing chamber, and the components are completely mixed into a slurry by rotation of a lower rotary mixing disk. However, the crude mixture pulsates in the course of being transferred to the lower mixing chamber, causing backflow of the mixture in the lower mixing chamber and into the upper mixing chamber. Since all of the powder and liquid are introduced into the upper mixing chamber, the powder and liquid are mixed in a dilute state from the outset, and this results in poor powder dispersibility.

U.S. Pat. No. 5,599,102 (Feb. 4, 1997) discloses a mixing apparatus for continuously manufacturing a low viscosity mixture by (i) introducing a powder and a liquid into a mixing chamber, (ii) preparing a crude mixture of powder and liquid by rotation of a rotary disk, (iii) replenishing the liquid from under the rotary disk, and (iv) mixing the liquid with the crude mixture. However, subsequently replenished liquid rises in the vicinity of the rotary disk, and when an emulsion is prepared, particle size increases and emulsions become unstable. When mixtures of a powder and liquid are prepared, viscosity of the mixture is too high.

### BRIEF SUMMARY OF THE INVENTION

Therefore, it is an object of the invention to provide a continuous mixing apparatus in which subsequently replenished liquid does not rise to the top of the mixing apparatus, and a mixture that is uniform, highly stable, and that has either a small particle size or a lower viscosity, can be quickly manufactured.

These and other features of the invention will become apparent from a consideration of the detailed description.

### BRIEF DESCRIPTION OF THE SEVERAL VIEWS OF THE DRAWING

FIG. 1 is a pictorial representation and cross sectional view of continuous mixing apparatus A according to one embodiment of the invention.

FIG. 2 is a pictorial representation and cross sectional view of continuous mixing apparatus in another embodiment of the invention. The apparatus in FIG. 2 is the same as the apparatus in FIG. 1 except that in FIG. 2 there is no liquid supply pipe 9c, and in FIG. 2a liquid supply pipe 9d for replenishing liquid in the lower mixing chamber 2d, passes through the outer sloped surface of inverted cone 1c.

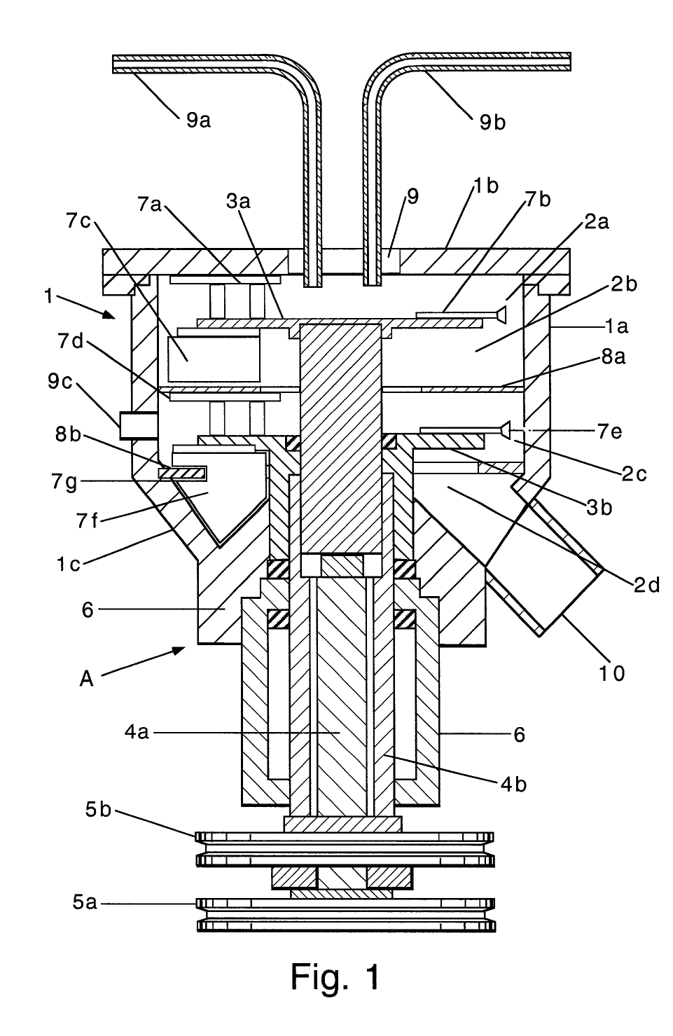

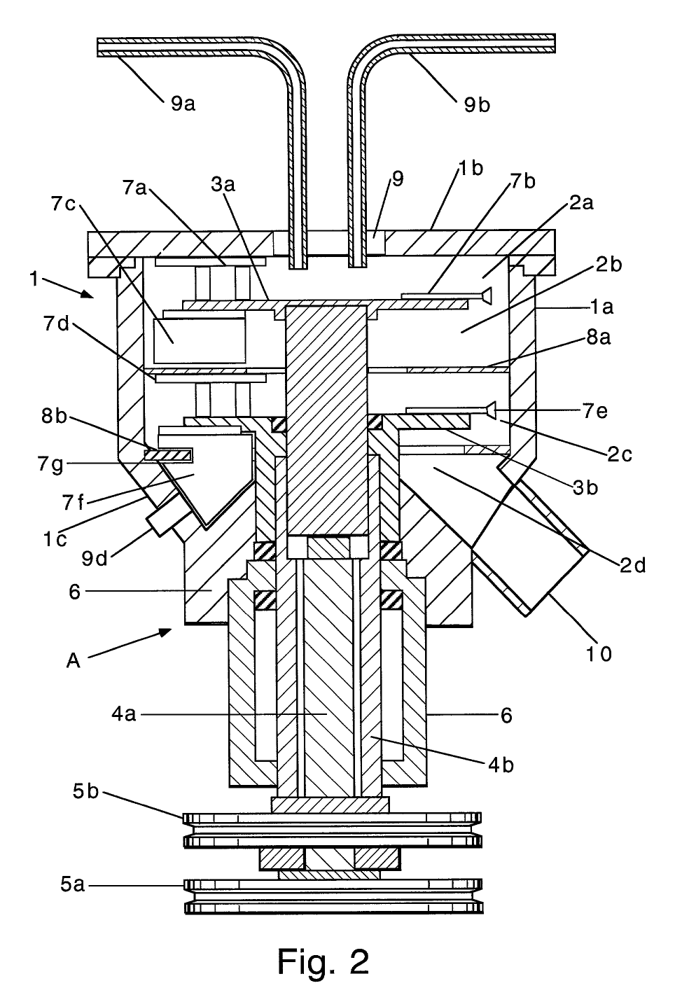

In FIGS. 1 and 2, similar parts are identified with the same numerals and letters. In the figures, A denotes one embodiment of continuous mixing apparatus, B denotes another embodiment of continuous mixing apparatus, 1 is the casing, 1a is the cylinder, 1b is the lid, 1c is the inverted cone, 2a is the uppermost mixing chamber, 2b is the upper mixing chamber, 2c is the middle mixing chamber, 2d is the lower mixing chamber, 3a is the upper rotary disk, 3b is the lower rotary disk, 4a is the rotary shaft, 4b is the rotary shaft, 5a is the pulley, 5b is the pulley, 6 is the bearing, 7a is the upper scraper, 7b is the lateral side scraper, 7c is the lower scraper, 7d is the upper scraper, 7e is the lateral side scraper, 7f is the lower scraper, 7g is the notch, 8a is the upper ring plate, 8b is the lower ring plate, 9 is the material supply port, 9a is the material supply pipe, 9b is the material supply pipe, 9c is the liquid supply pipe, 9d is the liquid supply pipe, and 10 is the discharge port.

### DETAILED DESCRIPTION OF THE INVENTION

The continuous mixing apparatus contains an upper rotary disk and a lower rotary disk that rotate independently of each other, and are disposed in a mixing chamber within a casing. Scrapers are attached to the upper and lower sides of the upper rotary disk, and to the upper and lower sides of the lower rotary disk. An upper ring plate extends from the inner walls of the casing in a non-contact state between the lower scraper of the upper rotary disk and the upper scraper of the lower rotary disk. A lower ring plate extends from the inner walls of the lower part of the casing, and intersects in a non-contact state with a notch of the lower scraper of the lower rotary disk.

The mixing chamber inside the casing is divided by the upper rotary disk, the upper ring plate, and the lower ring plate, into an uppermost mixing chamber, an upper mixing chamber, a middle mixing chamber, and a lower mixing chamber. A material supply port for supplying different types of material to the uppermost mixing chamber is located in the upper portion of the casing. A liquid supply port for replenishing liquid in the middle mixing chamber or in the lower mixing chamber, is located in the side wall of the casing. A discharge port for discharging the mixture from the lower mixing chamber is located at the bottom of the casing.

In the continuous mixing apparatus, different types of material such as a powder and a liquid, different types of powders, or different types of liquids, supplied to the uppermost mixing chamber, (i) move radially outward over the rotating upper rotary disk and adhere to the ceiling of the mixing chamber, (ii) are scraped off by the upper scraper, and (iii) are subjected to shearing action. Scraped off material falls onto the upper rotary disk and continues to move radially outward over the rotating upper rotary disk. The material is thereby subjected to a first kneading action and becomes a crude mixture. The crude mixture moves through the space between the edge of the upper rotary disk and the inner wall of the casing, into the upper mixing chamber, and is scraped off by the lower scraper of the upper rotary disk, and thereby subjected to shearing action. As a result, the material is subjected to a second kneading action and forms a more uniform crude mixture.

The crude mixture moves through the space between the upper ring plate and the rotary shaft into the middle mixing chamber, where it moves radially outward over the lower rotary disk and adheres to the lower side of the upper ring plate. It is scraped off by the upper scraper of the lower rotary disk, and is subjected to shearing action. Scraped off crude mixture moves onto the lower rotary disk and once again moves radially outward over the lower rotary disk. The material is subjected to a third kneading action and forms an even more uniform crude mixture. The crude mixture continues to move through the space between the edge of the ring plate and the surface of the bearing into the lower mixing chamber, where any mixture adhering to the sloped surface at the bottom of the casing and the lower ring plate is scraped off by the lower scraper of the lower rotary disk, and subjected to shearing action.

As a result, the material is subjected to four kneading actions. During this time, the crude mixture is diluted by the addition of liquid supplied from a liquid supply pipe located in the side wall of the casing in the middle mixing chamber in one embodiment, or in the side wall of the casing in the lower mixing chamber in another embodiment. After having been kneaded four times and diluted with replenishing liquid, the mixture is discharged from the apparatus from a discharge port located at the bottom of the casing.

The material being mixed in the apparatus is a fluid, typically a mixture of a liquid and a powder. The powder need not be a single material but it can be a mixture of different types of powder. Some examples of powders include starch, wheat, pigments, metal powders, powdered fillers, powdered polymers, and rubber powders. Some examples of powdered fillers include hydrophobically treated fumed silica, wet silica, diatomaceous earth powder, quartz powder, calcium carbonate powder, magnesium oxide powder, alumina powder, and carbon black. Some examples of powdered polymers include silicone resin powders and various types of thermoplastic resin powder.

Similarly, the liquid need not be pure but can be a liquid such as a solution. Some examples of liquids include aqueous solutions, malt syrup, edible oils, organic solvents, nonaqueous solutions, liquid compounds, and liquid polymers. Some examples of liquid compounds include emulsifiers, surfactants, thickeners, plasticizers, and stabilizers. Some examples of liquid polymers include liquid silicone polymers, liquid polybutadiene, liquid polybutene, liquid polyurethane, and liquid epoxy resins.

The continuous mixing apparatus is especially useful in the continuous mixing of different types of materials such as a powder and a liquid, different types of powders, or different types of liquids. The term different types of powder is intended to include, for example, powders of the same type of material but with particles of different shapes or average size. The term different types of liquid is intended to include, for example, liquids of the same material but of different viscosity. Some examples include diorganopolysiloxanes in the form of raw rubber, low viscosity diorganopolysiloxanes, and solutions thereof with different concentration.

Some examples of replenishing liquids that may be used according to this invention include liquids which are the same as the liquid used in the crude mixture, or the replenishing liquid can be different.

The mixture discharged from the continuous mixing apparatus can be in many different forms depending on the type of materials being mixed and the blend ratios thereof. Some examples include compounds, slurries, pastes, grease, emulsions, dispersions, and solutions. The continuous mixing apparatus is particularly useful for manufacture of (i) emulsions using an emulsifier to emulsify a liquid such as a liquid polymer in water, or for manufacture of (ii) compounds, slurries, or pastes, by mixing liquids such as liquid polymers with powders such as reinforcing fillers.

With reference now to the drawing, FIG. 1 represents one embodiment of continuous mixing apparatus A according to the invention. In FIG. 1, an upper rotary disk 3a and a lower rotary disk 3b rotate independently of each other, and are disposed horizontally in mixing chambers 2a, 2b, 2c, and 2d, within casing 1. The center of the upper rotary disk 3a is fixed to the upper end of rotary shaft 4a, and the center of the lower rotary disk 3b is fixed to the upper end of rotary shaft 4b. Rotary shaft 4a is located in rotary shaft 4b but shafts 4a and 4b rotate independently of one another. Pulley 5a is attached to the base of rotary shaft 4a, and rotary shaft 4a is rotated by transmission of rotation by a first motor which is not shown.

The peripheral velocity of upper rotary disk 3a is preferably 3-240 m/sec. Pulley 5b is attached to the base of rotary shaft 4b, and rotary shaft 4b is rotated by transmission of rotation by a second motor which is not shown. The peripheral velocity of lower rotary disk 3b is preferably 3-60 m/sec. As long as the peripheral velocity of upper rotary disk 3a is higher than the peripheral velocity of lower rotary disk 3b, replenishing liquid coming from the liquid supply pipe will not rise and infiltrate the uppermost mixing chamber and the upper mixing chamber. It is preferred to maintain the peripheral velocity of upper rotary disk 3a higher than the peripheral velocity of lower rotary disk 3b. Therefore, the ratio between the peripheral velocity of upper rotary disk 3a and the peripheral velocity of lower rotary disk 3b is preferably 4:1, to slightly more than 1:1, excluding the ratio 1.0:1.0.

Rotary shaft 4b is supported by bearing 6. Scraper 7a is attached to the upper side of upper rotary disk 3a, scraper 7b is attached to the lateral side of upper rotary disk 3a, and scraper 7c is attached to the lower side of upper rotary disk 3a. Scraper 7d is attached to the upper side of lower rotary disk 3b, scraper 7e is attached to the lateral side of lower rotary disk 3b, and scraper 7f is attached to the lower side of lower rotary disk 3b. Lateral side scrapers 7b and 7e are not essential to operation of the apparatus and can be omitted, if desired. While only a single scraper can be employed for each rotary disk, two or more scrapers are preferably employed for each rotary disk. When two or more scrapers are used, however, they should be positioned equiangularly of the centerline of shafts 4a and 4b.

Scraper 7f attached to the lower side of lower rotary disk 3b is in the form of a sheet or lattice, and extends radially and vertically. Horizontal notch 7g is cut in lower scraper 7f and extends inwardly towards rotary shafts 4a and 4b. Scraper 7f is capable of relative movement with respect to lower ring plate 8b.

Upper ring plate 8a extends from the inner wall of cylinder 1 a of casing 1 between lower scraper 7c of upper rotary disk 3a and upper scraper 7d of lower rotary disk 3b, and there is a space between rotary shaft 4a and the edge of upper ring plate 8a through which the mixture may pass. Lower ring plate 8b extends from the inner wall of inverted cone 1 c of casing 1, and intersects in a non-contact state with notch 7g of lower scraper 7f of lower rotary disk 3b. Lower rotary disk 3b rotates in this mode.

The mixing chamber of casing 1 is divided by upper rotary disk 3a, upper ring plate 8a, and lower ring plate 8b, into uppermost mixing chamber 2a, upper mixing chamber 2b, middle mixing chamber 2c, and lower mixing chamber 2d. Material supply ports 9a and 9b for supplying different types of material into uppermost mixing chamber 2a, are provided in the center of lid 1b of casing 1. The lower end of material supply pipes 9a and 9b are located in uppermost mixing chamber 2a.

Liquid supply pipe 9c for replenishing liquid in middle mixing chamber 2c passes through cylinder 1a of casing 1. Inverted cone portion 1c is contiguous with the bottom portion of cylinder 1a. Bearing 6 extends upwardly from the center of inverted cone 1c forming a depression that is annular and V-shaped in cross section. Discharge port 10 for discharging the final mixture from lower mixing chamber 2d is located in inverted cone 1c, and forms the bottom portion of casing 1.

### EXAMPLE

The following example is set forth in order to illustrate the invention in more detail.

### Application Example

Using continuous mixing apparatus A as depicted in FIG. 1, a dimethylpolysiloxane fluid terminated at each end of its chain with trimethylsiloxy groups, and having a viscosity of 3000 mPa s, was continuously supplied from material supply pipe 9a to uppermost mixing chamber 2a by a metering pump (not shown) while upper rotary disk 3a and lower rotary disk 3b were rotating. The peripheral velocity of upper rotary disk 3a was 24 m/sec, and the peripheral velocity of lower rotary disk 3b was 12 m/sec. An aqueous solution of cetyltrimethyl ammonium chloride in which the weight ratio of cetyltrimethyl ammonium chloride and water was 0.6:1.4, was continuously supplied from material supply pipe 9b to uppermost mixing chamber 2a by a metering pump (not shown). The weight ratio of dimethylpolysiloxane and aqueous solution of cetyltrimethyl ammonium chloride was 100:2.0. An emulsion in the form of a high viscosity grease was prepared as a result. At the same time, water was continuously supplied from liquid supply pipe 9c to middle mixing chamber 2c by another metering pump (not shown). An oil-in-water dimethylpolysiloxane emulsion was continuously discharged from discharge port 10. The particle size of dimethylpolysiloxane in the oil-in-water emulsion was approximately 0.4 μm, and the oil-in-water emulsion remained stable when stored for extended periods.

It should be apparent from the example, that different types of fluid materials can be mixed using the continuous mixing apparatus of the invention, and that any subsequently introduced replenished liquid does not rise to the top of the apparatus. Mixtures can be manufactured quickly, and are uniform, highly stable, and have small particle size or low viscosity.

Other variations may be made in compounds, compositions, and methods described herein without departing from the essential features of the invention. The embodiments of the invention specifically illustrated herein are exemplary only and not intended as limitations on their scope except as defined in the appended claims.

1. A continuous mixing apparatus comprising a casing; an upper rotary disk and a lower rotary disk capable of being rotated independently, disposed in a mixing chamber within the casing; a plurality of scrapers attached to upper and lower sides of upper rotary disk and to the upper and lower sides of lower rotary disk; an upper ring plate extending from the inner wall of the casing between a lower one of the scrapers of the upper rotary disk and an upper scraper of the lower rotary disk; a lower ring plate extending from the inner wall of the casing in a lower portion thereof, the scrapers on the lower side of the lower rotary disk having a notch enabling the scrapers on the lower side of the lower rotary disk to pass over the lower ring plate; the mixing chamber inside the casing being divided by the upper rotary disk, the upper ring plate, and the lower ring plate, into an uppermost mixing chamber, an upper mixing chamber, a middle mixing chamber, and a lower mixing chamber, respectively; material supply ports in the upper portion of the casing for supplying different types of materials to the uppermost mixing chamber; a liquid supply port for feeding replenishing liquid, the liquid supply port extending through the side wall of the casing to the middle mixing chamber or the lower mixing chamber; and a discharge port in the lower mixing chamber for discharging the mixture of materials.

2. The continuous mixing apparatus according to claim 1 wherein the ratio of the rotational speed of the upper rotary disk and the rotational speed of the lower rotary disk is 4:1 to more than 1.0 to 1.0.

3. The continuous mixing apparatus according to claim 1 wherein the different types of material are liquids.

4. The continuous mixing apparatus according to claim 3 wherein the different types of liquid are a silicone oil and an emulsifier; wherein the replenishing liquid is water; and wherein the mixture of materials is an aqueous emulsion containing the silicone oil.
